(19) United States
(12) Patent Application Publication
(10) Pub. No.: US 2010/0123293 A1
(43) Pub. Date: May 20, 2010

(54) Mechanic's creeper with onboard lighting

(76) Inventor: John Russell Benjamin, Roscoe, IL (US)

Correspondence Address: John Benjamin, 6746 Meadowbrook, Roscoe, IL, 61073, US

(21) Appl. No.: 12/590,938

(22) Filed: Nov. 17, 2009

Related U.S. Application Data
(60) Provisional application No. 61/199,558, filed on Nov. 18, 2008.

(51) Int. Cl. B25H 5/00; F21S 4/00; F21L 4/00; H05B 37/02

(52) U.S. Cl. 280/32.6; 362/249.01; 362/228; 362/183; 315/294

(57) ABSTRACT

Disclosed is a mechanic's creeper equipped with a lighting system. Lights can be placed on a bar surrounding the mechanic's head like a halo. In this position, the lights illuminate the area where the mechanic needs to work without getting light in the mechanic's eyes or casting annoying shadows. The creeper can include a battery to power the lights. A rechargeable battery can be provided, with the battery recharging when the creeper is not in use. A “low charge” indicator can be included. Many types of lighting fixtures are contemplated, but LEDs are preferred because they are rugged and produce a good deal of even light without drawing too much power. When multiple LEDs are used, different LEDs can be aimed in slightly different directions to more evenly illuminate the work area under the automobile. A lighting unit can be made as an add-on to attach to an existing creeper.

### CROSS-REFERENCE TO RELATED APPLICATION

This application claims priority to U.S. Provisional Patent Application 61/199,558, filed on Nov. 18, 2008, which is incorporated herein by reference in its entirety.

### FIELD OF THE INVENTION

The present invention is related generally to mechanical tools and, more particularly, to mechanic's creepers used, for example, while working under cars.

### BACKGROUND OF THE INVENTION

Even the best garage lighting throws shadows under the cars. Because of this, when a mechanic needs to work under a car, he brings a utility light with him. For a car raised on a lift, this is not a serious inconvenience. However, sometimes the mechanic must work under a car that is either not raised up at all or is only raised a little bit. In this case, the mechanic lies down on his creeper and rolls under the car to work, bringing with him the utility light trailing its long electrical cord.

That cord often gets in the way of the mechanic and his creeper, especially when the mechanic needs to roll from one position under the car to another.

The mechanic's utility light has other disadvantages. The utility light is often hooked underneath the car to free up both of the mechanic's hands for work, but that arrangement often shines too much light in the mechanic's eyes and not enough light where the mechanic needs it. In addition, a utility light hooked underneath the car casts annoying shadows when its light is blocked by pieces of the car.

### BRIEF SUMMARY

The above considerations, and others, are addressed by the present invention, which can be understood by referring to the specification, drawings, and claims. According to aspects of the present invention, a mechanic's creeper is equipped with its own lighting system. In some embodiments, lights are placed on a light bar surrounding the mechanic's head like a halo. In this position, the lights illuminate the area where the mechanic needs to work without getting light in the mechanic's eyes or casting annoying shadows.

In a preferred embodiment, the creeper includes a battery to power the lights, thus eliminating problems with the traditional power cord. A rechargeable battery is preferred, with the battery recharging when the creeper is not in use. A “low charge” indicator can be included.

While many types of lighting fixtures are contemplated, a preferred embodiment includes a number of light-emitting diodes (“LEDs”). LEDs are rugged and produce a good deal of even light without drawing too much power. When multiple LEDs are used, different LEDs can be aimed in slightly different directions to more evenly illuminate the work area under the automobile.

In some embodiments, the lighting fixture, along with the battery and controls, is constructed as a sealed unit to keep out dirt, water, and other automotive liquids. This unit can be made as an add-on to attach to an existing creeper. In a preferred embodiment, a creeper is built with an integral lighting fixture to save on manufacturing costs.

### BRIEF DESCRIPTION OF THE SEVERAL VIEWS OF THE DRAWINGS

The invention, together with its objects and advantages, may be best understood from the following detailed description taken in conjunction with the accompanying drawings of which:

FIG. 1a is a top-down view of a creeper carrying its own lighting system, according to some aspects of the present invention;

FIG. 1b is a side elevation of the creeper of FIG. 1a;

FIG. 1c is an end view of the creeper of FIG. 1a;

FIG. 2 is a cross-section through the light bar of the creeper of FIG. 1a;

FIG. 3a is a top-down view of a creeper with multiple LEDs, showing the lighting pattern produced by the LEDs; and

FIG. 3b is a side view of the creeper of FIG. 3a, showing the direction of LED lighting.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

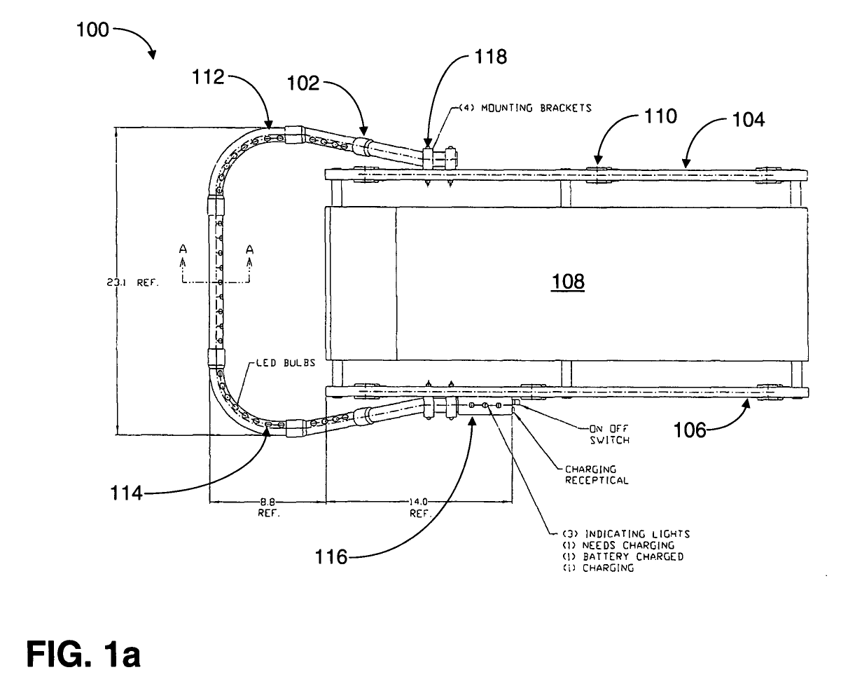

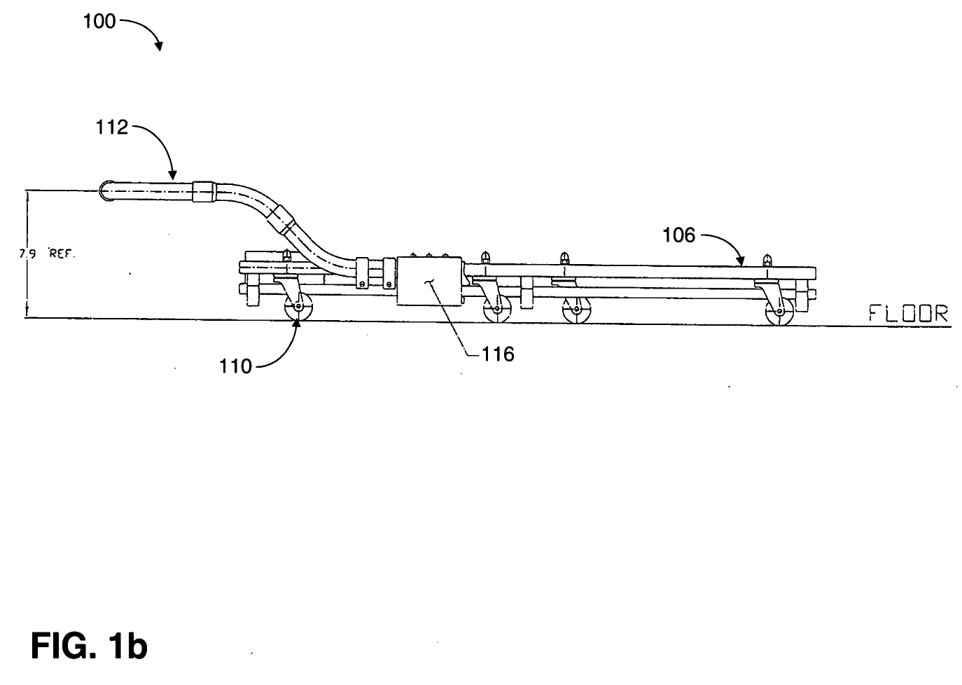

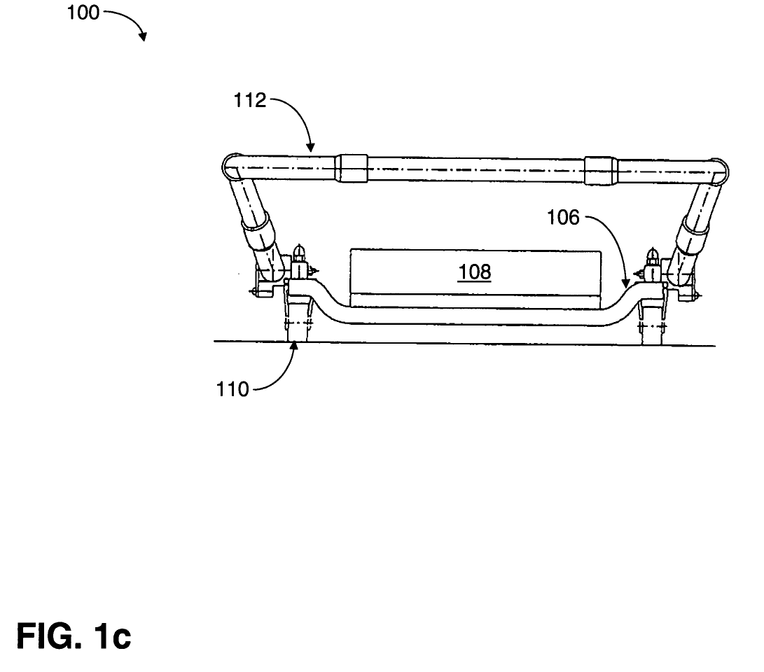

FIG. 1a is a top-down view of a creeper 100 with an onboard lighting system 102. The basic creeper 104 (that is to say, the creeper 100 without the lighting system 102) can be of any known type and generally includes a frame 106, a bed 108 for supporting the mechanic while he works, and several wheels 110 (seen better in the side elevation of FIG. 1b). Attached (or made integrally with) the frame 106 of the creeper 100 is the lighting system 102. In the exemplary embodiment of FIG. 1a, the lighting system 102 includes a light bar 112 that surrounds the head of mechanic like a halo when the mechanic is lying on the creeper 100. The light bar 112 of FIG. 1a includes a number of LEDs 114 to illuminate the underside of an automobile. The LEDs are powered by a battery contained in a control unit 116 of the creeper 100. (An embodiment is contemplated that uses a traditional plug-in electrical cord to power the lights 114. This embodiment might provide better lighting, but the cord is a major inconvenience, and it is expected that few, if any, corded creepers will ever be made.) The control system 116 (with, e.g., an on/off switch, a battery-charge-level indicator, a battery recharging port, and possibly an illumination level control) is used by the mechanic to adjust the level of illumination that he needs.

In FIG. 1a, the lighting system 102 is shown bolted 118 to the frame 106 of the creeper 100. It is possible to manufacture the frame 106 of the creeper 100 with the light bar 112 as an integral part, thus lowering manufacturing costs. In other embodiments, the lighting system 102 is made as an add-on kit to attach to an existing basic creeper 104. In any case, it is contemplated that the light bar 112 is quite strong and is able to handle the inevitable hard contacts in the garage.

FIG. 1b shows the creeper 100 of FIG. 1a from the side, and FIG. 1c shows the creeper 100 from the head end. Note that the battery (contained in the control unit 116 of FIG. 1b and expected to be somewhat heavy) is placed near the center of the creeper 100 (from front to back). Note also that the light bar 112 increases the height of the creeper 100 by only a small amount, making this creeper 100 as maneuverable under an automobile as a traditional, non-lighted creeper. The light bar 112 can be made lower than is shown in FIGS. 1b and 1c, but if it is too low, then the light from the LEDs 114 might annoy the mechanic.

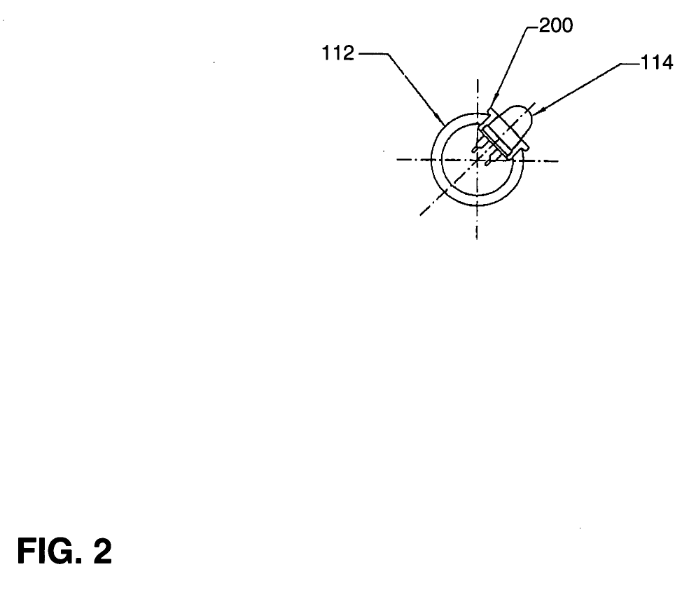

In FIG. 2, one of the LEDs 114 is shown held in place by a mounting clip 200 to the light bar 112. It is expected that the wiring (not shown) for the LEDs 114 will run inside the hollow light bar 112, although that is not a requirement.

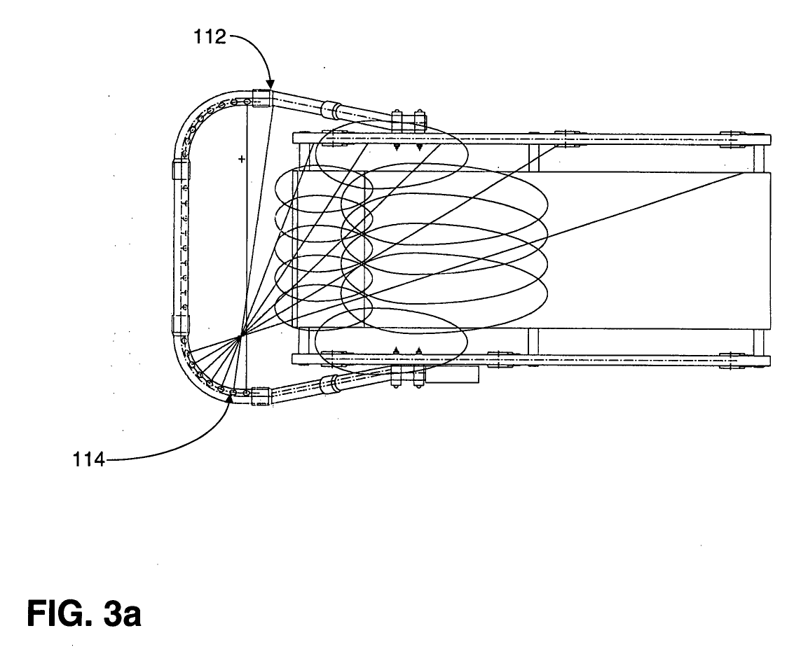

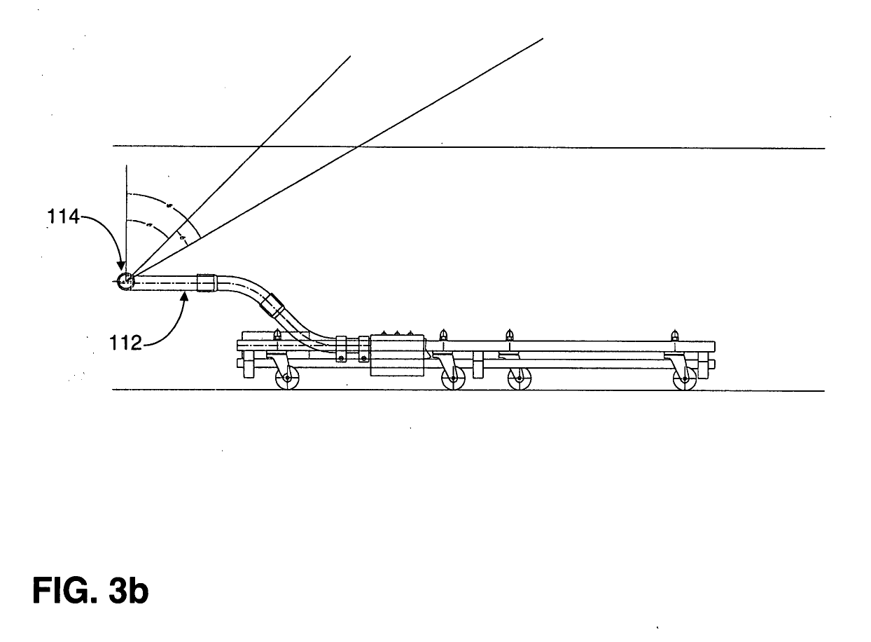

FIG. 3a is similar to FIG. 1a, but FIG. 3a illustrates one possible pattern of illumination generated by the LEDs 114. Each LED 114 is positioned in the light bar 112 so that the combination of light from all of the LEDs 114 illuminates the work area above the mechanic's head evenly and without annoying shadows. This even illumination is a preferred feature of the invention. A demonstration model has been built, and it provides illumination far better than any known utility light.

In FIG. 3b, the principle direction of illumination from two exemplary LEDs 114 is shown. By angling different LEDs 114 slightly differently, a large work area can be well illuminated. While other lighting systems are possible (fluorescent lighting in the light bar 112 is contemplated), it is expected that the benefits of the LEDs 114 will make this the most common embodiment.

In view of the many possible embodiments to which the principles of the present invention may be applied, it should be recognized that the embodiments described herein with respect to the drawing figures are meant to be illustrative only and should not be taken as limiting the scope of the invention. For example, the illumination patterns in the figures are only meant to illustrate the functions of the lighting system and are not meant to be definitive. Other arrangements of the lighting components shown in the figures are possible and may be called for in various environments.

I claim:

1. A mechanic's creeper comprising:
a frame;
a plurality of wheels attached to the frame;
a bed attached to the frame; and
a lighting system attached to the frame, the lighting system comprising at least one light.

2. The mechanic's creeper of claim 1 wherein the light is selected from the group consisting of: an incandescent bulb, a fluorescent tube, and a light-emitting diode.

3. The mechanic's creeper of claim 1 wherein an orientation of the light with respect to the creeper is adjustable.

4. The mechanic's creeper of claim 1 wherein the lighting system comprises a plurality of lights.

5. The mechanic's creeper of claim 4 wherein orientations of a plurality of the lights are individually adjustable.

6. The mechanic's creeper of claim 1:
wherein the creeper comprises a head end and a foot end; and
wherein the lighting system comprises a light bar attached to the frame, the light bar substantially surrounding the head end of the creeper.

7. The mechanic's creeper of claim 1 wherein the lighting system comprises an electric-power cord.

8. The mechanic's creeper of claim 1 wherein the lighting system comprises a battery.

9. The mechanic's creeper of claim 8 wherein the battery is rechargeable.

10. The mechanic's creeper of claim 1 wherein the lighting system comprises a control unit.

11. The mechanic's creeper of claim 10 wherein the control unit comprises a first control for turning the lighting system on and off and a second control for varying an amount of illumination provided by the lighting system.

12. The mechanic's creeper of claim 11:
wherein the lighting system further comprises a battery; and
wherein the control unit further comprises a “low battery charge” indicator.

13. A lighting system configured for attaching to a mechanic's creeper, the lighting system comprising at least one light.

14. The lighting system of claim 13 wherein the light is selected from the group consisting of: an incandescent bulb, a fluorescent tube, and a light-emitting diode.

15. The lighting system of claim 13 further comprising:
a plurality of lights.

16. The lighting system of claim 13 further comprising:
a battery.

17. The lighting system of claim 16 wherein the battery is rechargeable.

18. The lighting system of claim 13 further comprising:
a control unit.

19. The lighting system of claim 18 wherein the control unit comprises a first control for turning the lighting system on and off and a second control for varying an amount of illumination provided by the lighting system.

20. The lighting system of claim 19:
wherein the lighting system further comprises a battery; and
wherein the control unit further comprises a “low battery charge” indicator.
